(19) United States
(12) Patent Application Publication
(10) Pub. No.: US 2023/0400322 A1
(43) Pub. Date: Dec. 14, 2023

(54) COMPUTER-READABLE MEDIUM, INFORMATION DISPLAY DEVICE, AND INFORMATION DISPLAY METHOD

(71) Applicant: Panasonic Intellectual Property Management Co., Ltd., Osaka (JP)

(72) Inventors: Takuya NAKAGAWA, OSAKA FU (JP); Fumio KOSUGE, KANAGAWA KEN (JP); Masao IKEDA, KANAGAWA KEN (JP); Shinya AIZAWA, KANAGAWA KEN (JP)

(73) Assignee: Panasonic Intellectual Property Management Co., Ltd., Osaka (JP)

(21) Appl. No.: 18/239,462

(22) Filed: Aug. 29, 2023

Related U.S. Application Data
(63) Continuation of application No. PCT/JP2021/048695, filed on Dec. 27, 2021.

(30) Foreign Application Priority Data
Mar. 25, 2021 (JP) 2021-052233

(51) Int. Cl. G01C 21/36; G08G 1/14

(52) U.S. Cl. CPC G01C 21/3685; G08G 1/14

(57) ABSTRACT

A non-transitory computer-readable medium stores programmed instructions. The instructions, when executed by a computer of an information display device that is able to communicate via a network with a navigation device configured to guide a vehicle to a parking location and includes a display, cause the computer to perform: acquiring, as parking location information, a current location of the vehicle transmitted from the navigation device that has detected parking of the vehicle; and causing the display to display a parking location in accordance with the acquired parking location information.

### CROSS-REFERENCE TO RELATED APPLICATIONS

This application is a continuation of International Application No. PCT/JP2021/048695, filed on Dec. 27, 2021 which claims the benefit of priority of the prior Japanese Patent Application No. 2021-052233, filed on Mar. 25, 2021, the entire contents of which are incorporated herein by reference.

### FIELD

The present disclosure relates to a computer-readable medium, an information display device, and an information display method.

### BACKGROUND

When parking a vehicle at a large parking lot such as a large commercial facility, a user may forget the location where the vehicle is parked after parking. However, in multistory parking lots with multi-layered parking lots and underground parking lots built underground, GPS radio waves are difficult to reach so that it is difficult to recognize accurately recognize own-vehicle location. In this regard, as a parking position storage system in a parking lot where GPS radio waves are difficult to reach, a technique to acquire information on the location where a vehicle is parked by using, for example, a vehicle inside/outside determination for a vehicle key by a keyless entry system or the like in an on-vehicle system is disclosed (Japanese Patent Application Laid-open No. 2019-185266).

Under these circumstances, there is a need to notify users of information on the location where vehicles are parked without installing new equipment, even in locations where GPS radio waves do not reach.

The present disclosure has been made in view of the above problem, and has a main object to provide a computer-readable medium, an information display device, and an information display method that can notify users of information on the location where vehicles are parked without installing new equipment, even in locations where GPS radio waves do not reach

### SUMMARY

A non-transitory computer-readable medium according to the present disclosure stores programmed instructions. The instructions, when executed by a computer of an information display device that is able to communicate via a network with a navigation device configured to guide a vehicle to a parking location and includes a display, cause the computer to perform: acquiring, as parking location information, a current location of the vehicle transmitted from the navigation device that has detected parking of the vehicle; and causing the display to display a parking location in accordance with the acquired parking location information.

### BRIEF DESCRIPTION OF THE DRAWINGS

FIG. 1 is a block diagram illustrating an example of the configuration of an information processing system according to an embodiment;

FIG. 2 is a diagram illustrating an example of a display format of guidance information according to an embodiment;

FIG. 3 is a diagram illustrating an example of a display format of guidance information according to an embodiment;

FIG. 4 is a diagram illustrating an example of a display format of guidance information according to an embodiment;

FIG. 5 is a diagram illustrating an example of a display format of parking location information according to an embodiment;

FIG. 6 is a diagram illustrating an example of a display format of parking location information according to an embodiment;

FIG. 7 is a diagram illustrating an example of parking lot network data according to an embodiment;

FIG. 8 is a diagram illustrating an example of a display format of full/vacancy information according to an embodiment;

FIG. 9 is a sequence diagram illustrating an example of an information processing procedure performed by an information presentation system according to an embodiment;

FIG. 10 is a sequence diagram illustrating an example of an information processing procedure performed by a parking location notification system according to an embodiment; and

FIG. 11 is a diagram illustrating an example of the hardware configuration of a navigation device according to an embodiment.

### DETAILED DESCRIPTION

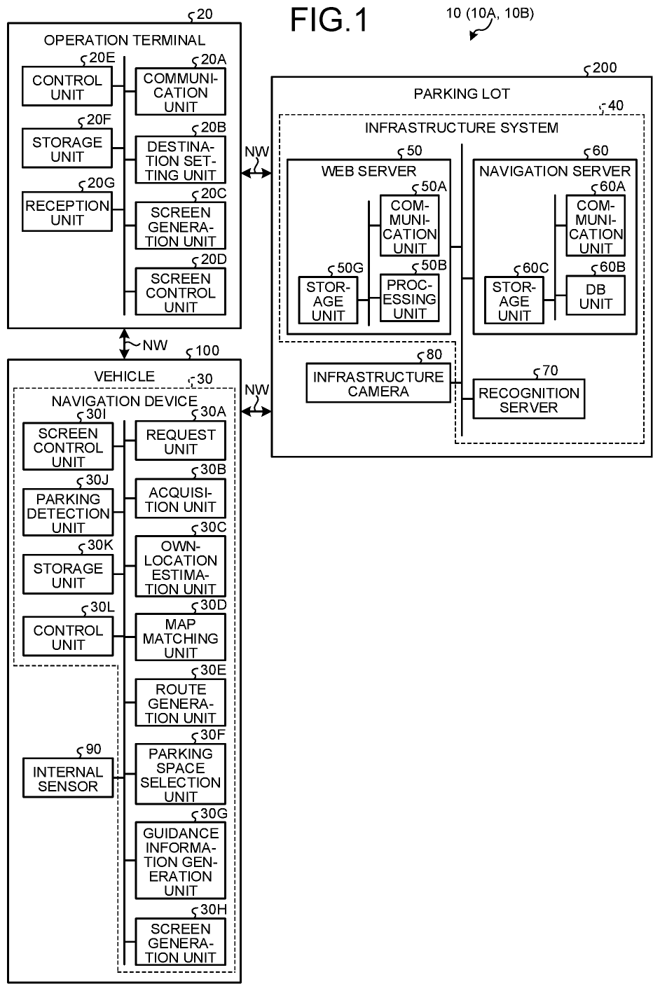

An information presentation method and a parking location notification method according to an embodiment are described below with reference to FIGS. 1 to 11.

The information presentation method according to the embodiment is used for an information presentation system 10A using a navigation device 30 that can communicate via a network with an information processing device having full/vacancy information indicating unoccupied parking spaces in a parking lot 200 and guides a vehicle 100 to a destination by displaying guidance information for guiding the vehicle 100. Specifically, the information presentation method identifies the own-vehicle location on the basis of parking lot network data, selects a parking space suitable for parking among unoccupied parking spaces in the parking lot 200, and outputs guidance information for guiding the vehicle 100 from a current location to the selected parking space. The parking space is, for example, a space where one vehicle can be parked.

The parking location notification method according to the embodiment is used for a parking location notification system 10B that notifies a user of information on the location where the vehicle 100 is parked. Specifically, the parking location notification method acquires information on the parking lot 200 where the vehicle 100 is parked and notifies location information of the vehicle 100 at the time when the parking was detected.

Configuration of Information Presentation System 10A and Parking Location Notification System 10B

First, the functional configuration of the information presentation system 10A and the parking location notification system 10B of the embodiment is described with reference to FIG. 1. FIG. 1 is a block diagram illustrating an example of the configuration of an information processing system 10 according to the embodiment.

The present embodiment illustrates the information processing system 10 configured to serve as the information presentation system 10A and the parking location notification system 10B as illustrated in FIG. 1. The information presentation system 10A is a system for presenting guidance information for guiding the vehicle 100 to a parking space in the parking lot 200. The parking location notification system 10B is a system for notifying a user of information on the location where the vehicle 100 is parked.

The information processing system 10 includes an operation terminal 20, the navigation device 30, and an infrastructure system 40 as illustrated in FIG. 1. The operation terminal 20, the navigation device 30, and the infrastructure system 40 communicate with one another through a communication network NW. The communication network NW is a mobile phone network with a large number of base stations as terminals, a satellite communication network using communication satellites, or the like.

Note that the information presentation system 10A and the parking location notification system 10B may have a common system configuration or may have independent system configurations. When the information presentation system 10A and the parking location notification system 10B have independent system configurations from each other, the information presentation system 10A only needs to have a function of implementing an information presentation method among the functions of the information processing system 10. Similarly, the parking location notification system 10B only needs to have a function of implementing a parking location notification method among the functions of the information processing system 10.

Configuration of Navigation Device 30

The navigation device 30 is a device that can communicate via a network with the infrastructure system 40 having full/vacancy information indicating unoccupied parking spaces in the parking lot 200 and guides the vehicle 100 to a destination. The navigation device 30 is mounted on the vehicle 100. The navigation device 30 has functions as a request unit 30A, an acquisition unit 30B, an own-location estimation unit 30C, a map matching unit 30D, a route generation unit 30E, a parking space selection unit 30F, a guidance information generation unit 30G, a screen generation unit 30H, a screen control unit 30I, a parking detection unit a storage unit 30K, and a control unit 30L.

The request unit 30A requests, from the infrastructure system 40, parking lot network data, full/vacancy information, and floor map data regarding the parking lot 200 located at a facility set as a destination by a user that operates a reception unit 20G of the operation terminal 20.

The acquisition unit 30B acquires the parking lot network data, the full/vacancy information, and the floor map data requested by the request unit 30A.

The own-location estimation unit 30C performs own-location estimation, which is a process of estimating where the vehicle 100 is located in road network data or the parking lot network data, on the basis of information acquired from an internal sensor 90 mounted on the vehicle 100. Known methods may be used for the own-location estimation method, and the own-location estimation method is not limited.

The map matching unit 30D identifies the own location estimated by the own-location estimation unit 30C, by map matching. For example, the map matching unit 30D compares a travel trajectory of the vehicle 100 identified on the basis of the information acquired from the internal sensor 90 with vector data around the vehicle 100 in the road network data or the parking lot network data. Next, the map matching unit identifies vector data similar to the shape of the travel trajectory of the vehicle 100 as an actual travel route. On the basis of the identified travel route, the map matching unit 30D further identifies the own-vehicle location in the road network data or the parking lot network data.

The route generation unit 30E generates a route from a current location of the vehicle 100 to the destination. For example, on the basis of the road network data and the own-vehicle location, the route generation unit 30E generates a route from the current location of the vehicle 100 to the facility. Alternatively, on the basis of the parking lot network data and the own-vehicle location, the route generation unit 30E generates a route from an entrance of the parking lot 200 located at the facility to the parking space selected by the parking space selection unit 30F.

The parking space selection unit 30F selects a destination parking space on the basis of the parking lot network data and the full/vacancy information. For example, when the navigation device 30 further has floor map data indicating the layout of stores included in the destination facility, the parking space selection unit 30F selects a parking space close to a store to be visited on the basis of the floor map data in addition to the parking lot network data and the full/vacancy information. By selecting parking spaces in this way, visitors can smoothly move between the parking spaces and stores to be visited, even in a large parking lot. The store included in the facility is an example of a space that a user plans to visit. Note that the space that the user plans to visit is not limited to a store, and may also be an event space within the facility or an area including a plurality of stores, or the like.

The guidance information generation unit 30G generates guidance information for guiding the vehicle 100 to the destination. Specifically, when a facility selected by a user is set as a destination, the guidance information generation unit 30G generates guidance information indicating a route to the entrance of the parking lot 200 on the basis of the road network data and the own-vehicle location, during the route to the parking lot 200. During the route from the entrance of the parking lot 200 to the selected parking space, the guidance information generation unit 30G generates guidance information indicating the route to the selected parking space on the basis of the parking lot network data and the own-vehicle location.

The screen generation unit 30H generates an image to be displayed on a display device of the navigation device 30.

The screen control unit 30I outputs the image generated by the screen generation unit 30H to the display device of the navigation device 30. In other words, the screen control unit 30I displays the image on the display device of the navigation device 30 with respect to a user. For example, the screen control unit 30I displays, as an image, the guidance information for guiding the vehicle 100 from the current location of the vehicle 100 to a parking space in the parking lot 200. Note that the guidance information may be output to a display device of the operation terminal 20.

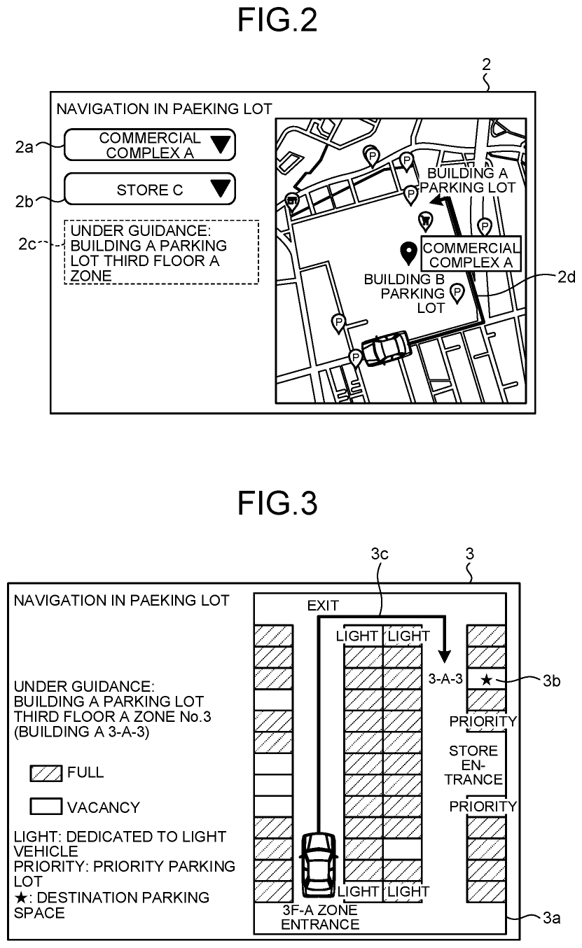

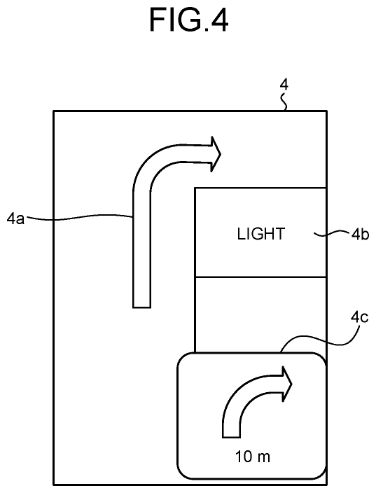

FIGS. 2 to 4 are diagrams illustrating examples of the display format of the guidance information according to the embodiment. An image indicating the guidance information includes, for example, a display image 2 illustrated in FIG. 2, which includes an indication 2a of a facility set by a user as a goal, an indication 2b of a store included in the facility, an indication 2c of a parking space selected as the destination among parking spaces in the parking lot 200 located at the facility, and an indication 2d of a route from a current location to the facility. Alternatively, the image indicating the guidance information includes, for example, a display image 3 illustrated in FIG. 3, which includes an indication 3a of full/vacancy information indicating unoccupied parking spaces in the parking lot 200, an indication 3b of the location of a parking space selected as a destination, and an indication 3c of a route from a current location to the selected parking space. Alternatively, the image indicating guidance information includes, for example, a display image 4 illustrated in FIG. 4, which includes an indication 4a indicating a route to a selected parking space, an indication 4b of a mark, and an indication 4c indicating steering operation on the route to the selected parking space. The display image 4 shows an example of a parking space dedicated to light vehicles as the indication 4b of a mark. The display image 4 also shows an example of an arrow indicating a right turn 10 meters ahead from the current location as the indication 4c indicating the steering operation. According to the indications of the display image 4, a user can know that he/she needs to turn right near the parking space dedicated to light vehicles, which is 10 meters ahead from the current location. Note that the display image 4 may be superimposed and displayed on the display image 3, for example.

The parking detection unit 30J detects parking of the vehicle 100. The parking detection unit 30J detects parking, for example, when a gear is put into a reverse range in the vehicle 100. Alternatively, the parking detection unit 30J detects parking when the own-vehicle location identified by the map matching unit 30D exists in the parking space selected as the destination in the parking lot network data.

The storage unit 30K accumulates the information acquired by the navigation device 30. In the present embodiment, the storage unit 30K accumulates, for example, parking lot network data, full/vacancy information, parking lot congestion information, floor map data, store contact entrance location data, and network data for walking acquired from the infrastructure system 40. In addition, the storage unit 30K accumulates road network data and road congestion information.

The control unit 30L controls the request unit 30A, the acquisition unit 30B, the own-location estimation unit 30C, the map matching unit 30D, the route generation unit 30E, the parking space selection unit 30F, the parking detection unit the storage unit 30K, and the like. The control unit for example, outputs the location information of the vehicle 100 at the time when parking is detected to the operation terminal 20 as parking location information.

Configuration of Operation Terminal 20

The operation terminal 20 is a terminal that receives instructions from a user. The operation terminal 20 is an example of an information display device. In the present embodiment, a smartphone is described as the operation terminal 20 as an example.

The operation terminal 20 has functions as a communication unit 20A, a destination setting unit 20B, a screen generation unit 20C, a screen control unit 20D, a control unit 20E, a storage unit 20F, and the reception unit 20G.

The communication unit 20A transmits and receives information to and from the navigation device 30 and the infrastructure system 40. For example, the communication unit 20A receives parking location information, which is information indicating the location where the vehicle 100 is parked, from the navigation device 30 via a known communication line such as Bluetooth (registered trademark).

The destination setting unit 20B transmits an instruction to the navigation device 30 to set, as a destination, a facility selected by a user via the reception unit 20G and a store included in the facility.

The screen generation unit 20C generates an image to be displayed on the display device of the operation terminal 20.

The screen control unit 20D outputs the image generated by the screen generation unit 20C to the display device of the operation terminal 20. In other words, the screen control unit 20D displays the image on the display device of the operation terminal 20 with respect to the user. For example, the screen control unit 20D displays the parking location information, which is the information indicating the location where the vehicle 100 is parked, as an image.

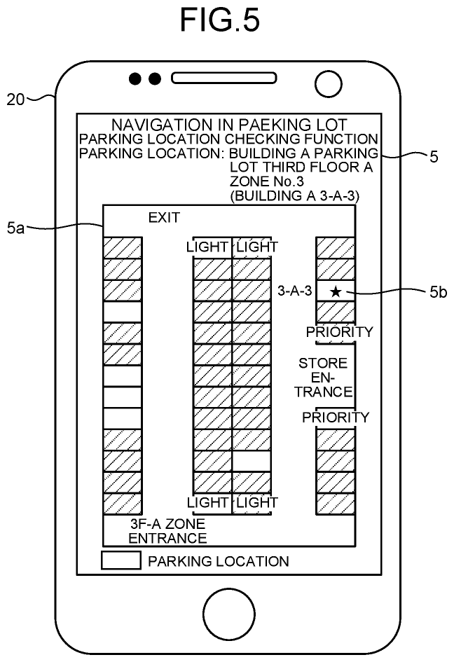

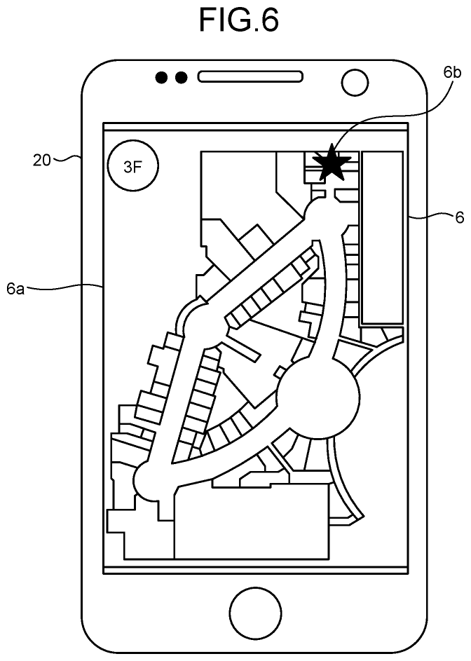

FIGS. 5 and 6 are diagrams illustrating examples of the display format of the parking location information according to the embodiment. An image indicating the parking location information includes, for example, a display image 5 illustrated in FIG. 5, which includes an indication 5a of the layout of parking spaces and an indication 5b of the location of a parking space where a vehicle is parked. As illustrated in FIG. 5, the indication 5b of the location of the parking space where the vehicle is parked is displayed with a predetermined symbol, for example, a star. Note that the location of the parking space where the vehicle is parked may be displayed with character information, for example, as in the indication 2c in FIG. 2. Alternatively, the image indicating the parking location information is an image indicating a contact entrance close to the parking space where the vehicle is parked among contact entrances to the parking lot 200, as in a display image 6 illustrated in FIG. 6. For example, as in the display image 6 illustrated in FIG. 6, the image indicating the parking location information includes an indication 6a of the layout of stores and contact entrances in the facility and an indication 6b of the location of a contact entrance close to the parking space where the vehicle is parked.

The control unit 20E controls the communication unit 20A, the destination setting unit 20B, the screen generation unit the screen control unit 20D, the storage unit 20F, and the reception unit 20G on the basis of the information acquired by the operation terminal 20.

The storage unit 20F accumulates the information acquired by the operation terminal 20. The storage unit 20F accumulates, for example, the parking location information and the like.

The reception unit 20G receives instructions or information input from a user.

Although a smartphone is described as an example of the operation terminal 20 in the present embodiment, the operation terminal 20 may be directly connected to the navigation device 30, or may be connected to the navigation device 30 via a network. Examples of the operation terminal directly connected to the navigation device 30 may include an in-vehicle display device serving as a car navigation system. Examples of the operation terminal 20 connected to the navigation device 30 via the network may include a portable information terminal such as a smartphone or a tablet. For the information presentation system 10A, the operation terminal 20 and the navigation device 30 may be configured as a single unit.

Note that similarly to the operation terminal 20, the navigation device 30, for example, may further have functions as a reception unit that receives user operations and a destination setting unit that sets a destination in response to the received user operations. For example, a user can select the indication 2a of the facility or the indication 2b of the store in the display image 2 in FIG. 2 and input or select a destination. At this time, the reception unit receives the destination input or selected by the user. The destination setting unit sets or changes the destination according to the user's input or selection received by the reception unit.

Configuration of Infrastructure System 40

The infrastructure system 40 is a server system for managing the parking lot 200 located at the facility set as the destinations by a user. The infrastructure system 40 is an example of an information processing device having full/vacancy information indicating unoccupied parking spaces in the parking lot 200. The infrastructure system 40 includes a web server 50, a navigation server 60, a recognition server 70, and an infrastructure camera 80.

Configuration of Web Server 50

The web server 50 provides information acquired from the navigation server 60 to the operation terminal 20 and the navigation device 30 via the network. Alternatively, the web server 50 acquires information from the operation terminal 20 and the navigation device 30.

As illustrated in FIG. 1, the web server 50 has functions as a communication unit 50A, a processing unit 50B, and a storage unit 50C.

The communication unit 50A transmits and receives information to and from the navigation device 30 and the navigation server 60. For example, the communication unit 50A transmits full/vacancy information, parking lot network data, floor map data, store contact entrance location data, parking lot congestion information, and network data for walking acquired from the navigation server 60 to the navigation device 30 via a known communication line such as Bluetooth (registered trademark).

The processing unit 50B processes the information transmitted and received by the communication unit 50A.

The storage unit 50C accumulates the information acquired by the web server 50. In the present embodiment, the storage unit 50C accumulates, for example, full/vacancy information, parking lot network data, floor map data, store contact entrance location data, parking lot congestion information, and network data for walking.

Configuration of Navigation Server 60

The navigation server 60 acquires real-time updated full/vacancy information, parking lot network data, floor map data, parking lot congestion information, and network data for walking from the recognition server 70, and provides the acquired information and data to the web server 50. As illustrated in FIG. 1, the navigation server 60 has functions as a communication unit 60A, a DB (database) unit 60B, and a storage unit 60C.

The communication unit 60A transmits and receives information to and from the web server 50 and the recognition server 70. For example, the communication unit 60A transmits real-time updated full/vacancy information, parking lot network data, floor map data, store contact entrance location data, parking lot congestion information, and network data for walking to the web server 50 via a known communication line such as Bluetooth (registered trademark).

The DB unit 60B manages the information acquired by the navigation server 60.

The storage unit 60C accumulates the full/vacancy information, the parking lot network data, the floor map data, the store contact entrance location data, the parking lot congestion information, and the network data for walking acquired by the navigation server 60.

Configuration of Recognition Server 70

The recognition server 70 updates the full/vacancy information and the parking lot congestion information in real time, and stores the updated parking lot information in the navigation server 60. Specifically, the recognition server 70 detects whether a parking space is unoccupied by analyzing images captured by the infrastructure camera 80 installed at the parking lot 200, and updates the full/vacancy information in real time. Alternatively, the recognition server 70 detects the location of the vehicle 100 traveling on a roadway in the parking lot 200 by analyzing images captured by the infrastructure camera 80 installed at the parking lot 200, and updates the parking lot congestion information in real time.

Configuration of Infrastructure Camera 80

The infrastructure camera 80 is a sensor that observes the inside of the parking lot 200. The infrastructure camera for example, captures images of parking spaces and roadways in the parking lot 200 to acquire in-parking lot image data. The infrastructure camera 80 is a digital camera, a stereo camera, or the like. The in-parking lot image data is digital image data with a pixel value defined for each pixel. The installation position and angle of view of the infrastructure camera 80 are adjusted in advance so that the inside of the parking lot 200 can be captured. In the present embodiment, a plurality of infrastructure cameras 80 with different shooting directions are provided at the parking lot 200.

Configuration of Internal Sensor 90

The internal sensor 90 is a sensor mounted on the vehicle 100 to observe information on the vehicle itself. The internal sensor 90 detects the location of the vehicle 100, the speed of the vehicle 100, the acceleration of the vehicle 100, or the like. The internal sensor 90 is, for example, an inertial measurement unit (IMU), a speed sensor, a vehicle speed pulse, an acceleration sensor, a global positioning system (GPS) receiver, or the like. The GPS receiver receives radio waves carrying downlink data including positioning data from a plurality of GPS satellites. The positioning data is used to detect the absolute location of the vehicle 100 from latitude and longitude information, or the like.

Information acquired by Information Presentation System and Parking Location Notification System 10B

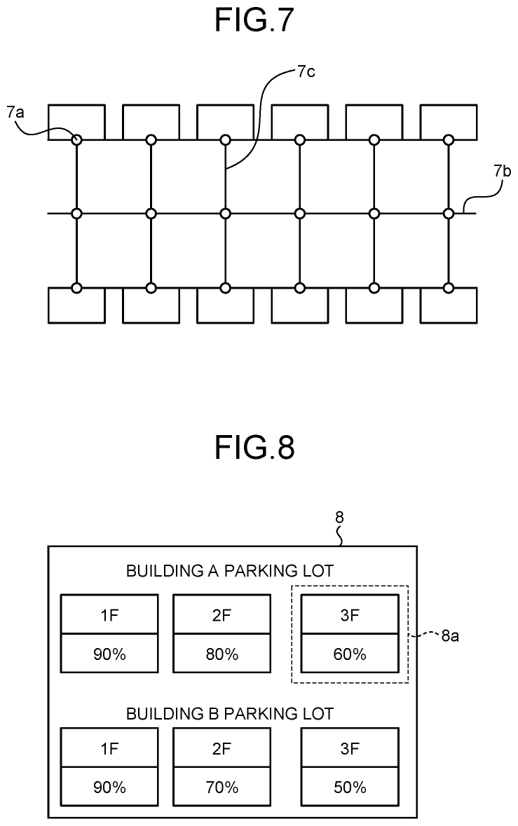

Information used in the information presentation system and the parking location notification system 10B is described with reference to FIGS. 7 and 8.

Parking Lot Network Data

The parking lot network data is information used to set a route to a destination parking space in the parking lot 200 located at the facility set as a destination by a user. The parking lot network data holds, as attributes, various information on parking spaces and roadways in the parking lot 200. FIG. 7 is a diagram illustrating an example of the parking lot network data according to the embodiment. As illustrated in FIG. 7, for example, the parking lot network data includes parking links 7b, which are vector data connecting parking points 7a respectively indicating the parking spaces in the parking lot 200, and lane links 7c which are vector data indicating the roadways in the parking lot 200.

The parking lot network data may be stored in the storage unit 30K of the navigation device 30, or may be stored in the storage unit 60C of the navigation server 60. When the parking lot network data is stored in the storage unit 30K of the navigation device 30, the acquisition unit acquires the parking lot network data from the storage unit 30K in response to a request for the parking lot network data from the request unit 30A. In other words, the parking lot network data is read by the navigation device 30.

Full/Vacancy Information

The full/vacancy information is information indicating unoccupied parking spaces in the parking lot 200. In the present embodiment, the recognition server 70 analyzes the images captured by the infrastructure camera 80 provided at the parking lot 200 and detects whether a parking space is unoccupied, so that the full/vacancy information is updated in real time. Note that the means for acquiring the full/vacancy information is not limited to the infrastructure camera 80 and the full/vacancy information may be acquired using a sensor that can detect a vehicle.

In addition, on the basis of the full/vacancy information, area-specific full/vacancy information indicating an occupation rate for each area may be calculated, the occupation rate being a rate of occupied parking spaces with respect to the parking spaces. The area is a certain range of places separated by a predetermined rule in the parking lot 200, and is, for example, a hierarchy for each parking building. FIG. 8 is a diagram illustrating an example of the display format of the full/vacancy information according to the embodiment. An image indicating the area-specific full/vacancy information includes a display image 8 illustrated in FIG. 8, which includes an indication 8a of an occupation rate for each floor for each parking building. The display image 8 shows building A parking lot and building B parking lot as parking buildings. In the example illustrated in FIG. 8, the building A parking lot and the building B parking lot are multi-layered parking lots, respectively. Note that the same indication is possible even though one of the parking lots is a flat parking lot. By outputting the image indicating the area-specific full/vacancy information to the display device of the operation terminal 20, a parking space in an area with less congestion can be selected, so that a vehicle can be parked smoothly.

Parking Lot Congestion Information

The parking lot congestion information is information indicating a congestion situation of the roadway in the parking lot 200. In the present embodiment, the parking lot congestion information is updated in real time as the recognition server 70 analyzes the images captured by the infrastructure camera 80 provided at the parking lot 200 and detects the location of the vehicle 100 traveling on the roadway in the parking lot 200. Note that the means for acquiring the parking lot congestion information is not limited to the infrastructure camera 80 and the full/vacancy information may be acquired using a sensor that can detect a vehicle.

Floor Map Data

The floor map data is information indicating the layout of the stores included in the facility set as a destination by a user. The floor map data may be stored in the storage unit 30K of the navigation device 30, or may be stored in the storage unit 60C of the navigation server 60.

Store Contact Entrance Location Data

The store contact entrance location data is information indicating the location of a contact entrance between the facility set as a destination by a user and the parking lot 200 located at the facility. The store contact entrance location data may be stored in the storage unit 30K of the navigation device 30, or may be stored in the storage unit of the navigation server 60.

Road Network Data

The road network data is information used to set a route to the facility set as a destination by a user. The road network data is data that holds various information on roads as attributes, and includes vector data connecting straight lines including latitude and longitude information. The vector data may be assigned to each road, or may be assigned to each lane of the road.

Road Congestion Information

The road congestion information is information indicating a congestion situation of a road from a departure place to the destination. The road congestion information is acquired, for example, from a vehicle information communication system (VICS) (registered trademark) center or a server device (not illustrated) that distributes congestion information.

Network Data for Walking

The network data for walking is information used to set and display a route that can be traveled in the shortest distance or the shortest time from the parking space of the parking lot 200 to a store set as a destination by a user. For example, the network data for walking holds, as attributes, various information on the parking spaces and the roadways in the parking lot 200 and various information on the layout of the stores included in the facility set as the destination and the store contact entrance locations. The network data for walking may be stored in the storage unit of the navigation device 30, or may be stored in the storage unit 60C of the navigation server 60.

Information Processing Procedure of Information Presentation System 10A

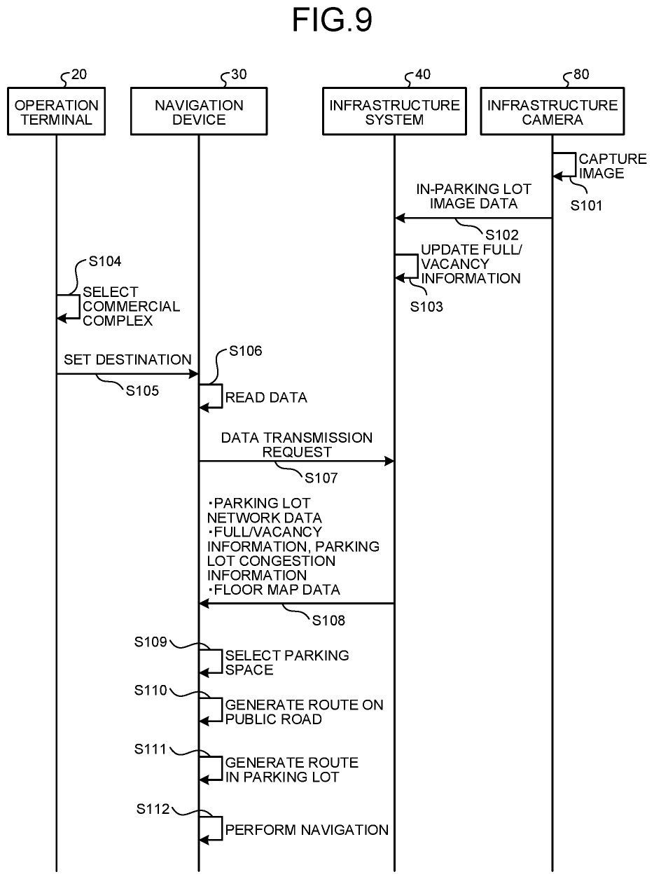

Next, an information processing procedure performed by the information presentation system 10A is described below with reference to FIG. 9. FIG. 9 is a sequence diagram illustrating an example of an information processing procedure performed by the information presentation system according to the embodiment.

The infrastructure camera 80 provided at the parking lot 200 acquires in-parking lot image data obtained by capturing the images of the parking spaces and the roadways in the parking lot 200 (step S101).

The infrastructure camera 80 outputs the in-parking lot image data acquired at step S101 to the recognition server 70 of the infrastructure system 40 (step S102).

The infrastructure system 40 updates the full/vacancy information and the parking lot congestion information in real time, and stores the updated full/vacancy information and parking lot congestion information in the navigation server 60 (step S103). Specifically, the recognition server analyzes the in-parking lot image data acquired from the infrastructure camera 80 and detects whether a parking space is unoccupied, thereby updating the full/vacancy information in real time and storing the updated full/vacancy information in the navigation server 60. Alternatively, the recognition server 70 analyzes the in-parking lot image data acquired from the infrastructure camera 80 and detects the location of the vehicle 100 traveling on the roadway in the parking lot 200, thereby updating the parking lot congestion information in real time and storing the updated parking lot congestion information in the navigation server 60.

A user selects a commercial complex and a store included in the commercial complex to be a goal via the reception unit Note that the user may select only the commercial complex as a goal, or may select a plurality of stores included in the commercial complex as goals (step S104).

Subsequently, the destination setting unit 20B transmits an instruction to the navigation device 30 to set, as a destination, the commercial complex and the store selected at step S104 (step S105).

The navigation device 30 reads, from the storage unit road network data from a current location to the commercial complex, parking lot network data regarding the parking lot 200 located at the commercial complex, and floor map data of the commercial complex (step S106).

The request unit 30A requests, from the infrastructure system 40, the parking lot network data, the full/vacancy information, the parking lot congestion information, and the floor map data of the commercial complex regarding the parking lot 200 located at the commercial complex (step S107).

The acquisition unit 30B acquires the road network data, the full/vacancy information, the parking lot congestion information, and the floor map data requested at step S107 from the web server 50 of the infrastructure system 40 (step S108). Note that the data already stored in the storage unit at step S106 is not acquired from the web server 50.

The parking space selection unit 30F selects a parking space close to the store selected by the user from unoccupied parking spaces in the parking lot 200, on the basis of the full/vacancy information and the floor map data (step S109).

The route generation unit 30E generates a route on a public road (step S110). Specifically, the own-location estimation unit 30C performs own-location estimation on the basis of information acquired from the internal sensor 90 such as a GPS receiver. The route generation unit 30E generates the route on the public road from a current location to the entrance of the parking lot 200 in the commercial complex on the basis of the road network data and the estimated own location.

The route generation unit 30E generates a route in the parking lot 200 (step S111). Specifically, the route generation unit 30E generates a route from the entrance of the parking lot 200 to the selected parking space on the basis of the parking lot network data and the own location estimated by the own-location estimation unit 30C.

Alternatively, the route generation unit 30E may generate the route from the entrance of the parking lot 200 to the selected parking space on the basis of the parking lot congestion information in addition to the parking lot network data and the own location estimated by the own-location estimation unit 30C. By generating the route on the basis of the parking lot congestion information, the vehicle 100 can travel to the parking space while avoiding congestion on the roadways in the parking lot 200.

Subsequently, the navigation device 30 performs navigation according to traveling conditions (step S112). Specifically, the map matching unit 30D identifies the own-vehicle location by map matching on the basis of the road network data and the parking lot network data. On the public road from the current location to the parking lot 200, the guidance information generation unit 30G generates guidance information indicating the route to the parking lot 200 on the basis of the road network data and the own-vehicle location. During the route from the entrance of the parking lot 200 to the selected parking space, the guidance information generation unit 30G generates guidance information indicating the route to the selected parking space on the basis of the parking lot network data and the own-vehicle location. The control unit 30L displays the generated guidance information on the display device of the navigation device 30.

In this way, even in a multistory parking lot or an underground parking lot where GPS radio waves are difficult to reach, the information presentation system 10A can select a parking space in the parking lot and output guidance information for guiding a vehicle to the selected parking space. That is, the information presentation method performed by the information presentation system 10A can improve the accuracy of identifying the own-vehicle location and perform route guidance to a destination parking location. In the information presentation system 10A, the navigation device 30 executes an information presentation program. The information presentation method is implemented, for example, by executing the information presentation program on the navigation device 30.

Information Processing Procedure of Parking Location Notification System 10B

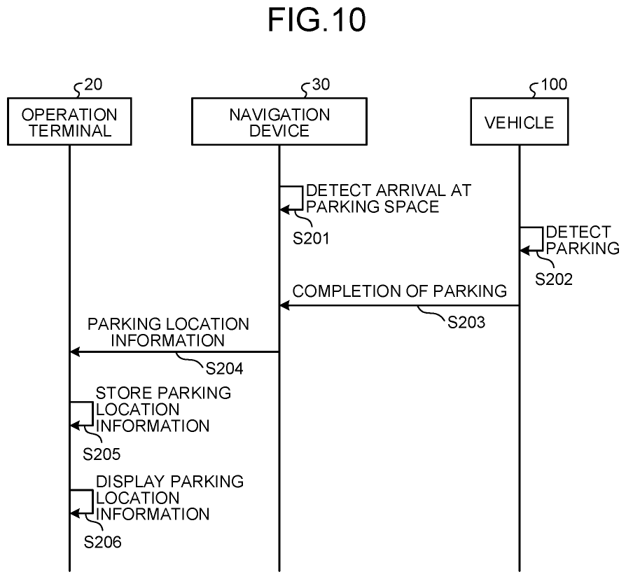

Next, an information processing procedure performed by the parking location notification system 10B is described below with reference to FIG. 10. FIG. 10 is a sequence diagram illustrating an example of an information processing procedure performed by the parking location notification system 10B according to the embodiment.

The navigation device 30 detects arrival at a parking space (step S201). For example, the termination of the information presentation system 10A is defined as arrival at the parking space.

The parking detection unit 30J detects parking of the vehicle 100 (step S202). The parking detection unit 30J detects parking by, for example, identifying the own-vehicle location by map matching and detecting that the vehicle 100 has approached the parking space. Alternatively, the parking detection unit 30J detects parking by, for example, receiving a signal indicating that a gear has been put into a reverse range in the vehicle 100.

The vehicle 100 notifies the navigation device 30 of the completion of parking (step S203).

The control unit 30L outputs the location information of the vehicle 100 at the time when parking is detected to the operation terminal 20 as parking location information (step S204).

The storage unit 20F stores the parking location information output at step S204 (step S205).

The screen control unit 20D displays the parking location information stored at step S205 on the display device of the operation terminal 20 as an image (step S206). For example, as illustrated in FIG. 5, the screen control unit 20D displays, on the display device of the operation terminal 20, the display image 5 including the indication 5a of the layout of the parking spaces in the parking lot 200 and the indication 5b of the location of the parking space where the vehicle 100 is parked. Alternatively, as illustrated in FIG. 6, the screen control unit 20D may display the display image 6 including the indication 6a of the layout of the stores and the contact entrances in the commercial complex and the indication 6b of the location of the contact entrance close to the parking space where the vehicle 100 is parked, on the basis of the store contact entrance location data.

In this way, according to the parking location notification system 10B, by notifying a user of information on the location where the vehicle 100 is parked, the user can smoothly find the location where the vehicle 100 is parked, even in a large parking lot located at a large commercial facility. That is, the parking location notification method performed by the parking location notification system 10B can notify the user of information on the location where the vehicle 100 is parked without installing any equipment at the parking lot 200 even in a place where GPS radio waves do not reach. In the parking location notification system 10B, the operation terminal 20 as an information display device executes an information display program. The parking location notification method is implemented, for example, by executing the information display program on the operation terminal 20 as the information display device.

First Variation

In the information presentation system 10A, in a case where a user sets a facility to be a goal, when a plurality of stores to be visited by the user are selected, the parking space selection unit 30F may extract a specific store from the selected stores and select a parking space close to the extracted store at step S109. For example, when a supermarket, a travel agency, a Chinese restaurant, a movie theater, and a general store are selected as stores to be visited, the parking space selection unit 30F extracts, as a specific store, the supermarket that is expected to have the largest number of goods, and selects a parking space located at the shortest distance from the extracted supermarket from unoccupied parking spaces. For example, the type and the like of store where the largest number of goods are expected to increase may be determined in advance and accumulated in the storage unit 30K. This allows a user to visit the supermarket last, thereby reducing the distance moved in a commercial complex with goods. Note that among the unoccupied parking spaces, a parking space that can be reached in the shortest time from the extracted supermarket may be selected.

Second Variation

In the information presentation system 10A, full/vacancy information is continuously acquired, and when the selected parking space is no longer an unoccupied parking space in the latest full/vacancy information, the parking space selection unit 30F may select a parking space as a new destination on the basis of the latest full/vacancy information. Thus, even though the parking space selected at step S109 is occupied by another vehicle, a vehicle can be parked at a parking space different from the occupied parking space.

Third Variation

In the above-described embodiment, the case of performing map matching on the basis of the travel trajectory of the vehicle 100 identified on the basis of information acquired from the internal sensor 90 mounted on the vehicle 100 and vector data around the vehicle 100 in the road network data or the parking lot network data has been described as an example. However, the infrastructure system may calculate the travel trajectory of the vehicle 100 and perform map matching. Specifically, the recognition server may detect the own-vehicle location traveling on the roadway in the parking lot 200 by analyzing the in-parking lot image data captured by the infrastructure camera 80 provided at the parking lot 200, and calculate the travel trajectory in the parking lot 200. The map matching unit 30D identifies the own-vehicle location by map matching on the basis of the travel trajectory calculated by the recognition server 70 in addition to the road network data and the parking lot network data.

Fourth Variation

In the information presentation system 10A, when a parking space is selected at step S109, the full/vacancy information may be processed with the selected parking space as a parking space that is not unoccupied. As an example, the parking space selection unit 30F outputs reservation information indicating the selected parking space to the infrastructure system 40. The infrastructure system 40 updates the full/vacancy information on the basis of the reservation information, and stores the updated full/vacancy information in the navigation server 60. That is, by outputting the reservation information indicating the parking space selected as a destination, the navigation device 30 causes the infrastructure system 40 to process the full/vacancy information so that the parking space is set as a parking space that is not unoccupied in the full/vacancy information. This can avoid a situation where the parking space selected at step S109 is occupied by another vehicle and parking of the own vehicle is not possible in the parking space.

Fifth Variation

When not only the commercial complex but also the stores included in the commercial complex are selected at step S104, the parking location notification system 10B may set a stored parking location as a starting point and location information indicating the location of a store to be visited as an end point, and display a route from the starting point to the end point on the display device of the operation terminal 20 as an image on the basis of the network data for walking regarding the commercial complex and the parking lot 200. The route from the starting point to the end point can be displayed, for example, in the same manner as parking location information. This enables a user to efficiently move from a parking space where the vehicle 100 is parked to the store.

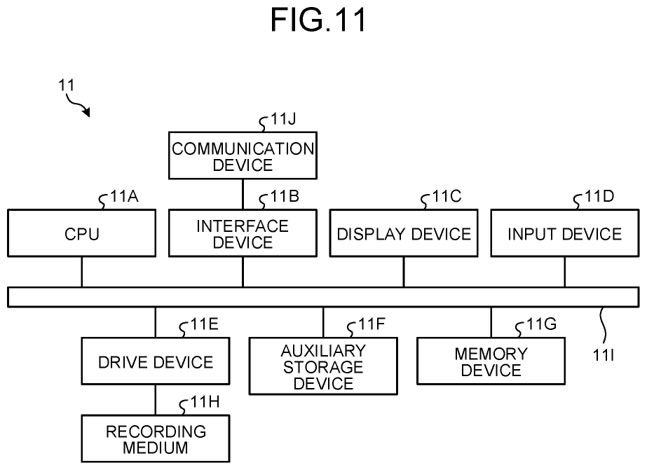

The hardware configuration of each device in the information processing system 10 according to the embodiment is described below. FIG. 11 is a diagram illustrating an example of the hardware configuration of the navigation device 30 according to the embodiment.

Example of Hardware Configuration of Navigation Device 30

First, an example of the hardware configuration of the navigation device 30 is described with reference to FIG. 11.

The navigation device 30 includes, as hardware 11, a central processing unit (CPU) 11A, an interface device 11B, a display device 11C, an input device 11D, a drive device 11E, an auxiliary storage device 11F, a memory device 11G, and a recording medium 11H.

The CPU 11A, the interface device 11B, the display device 11C, the input device 11D, the drive device 11E, the auxiliary storage device 11F, and the memory device 11G are connected to one another by a bus line 11I.

Computer programs for implementing various functions of the navigation device 30 are provided by the recording medium 11H, for example. As the recording medium 11H, a computer readable recording medium such as a CD-ROM, a flexible disk (FD), a CD-R, and a digital versatile disc (DVD) can be used as appropriate.

The drive device 11E is a device that writes information to the recording medium 11H or a device that reads information from the recording medium 11H. When the drive device 11E reads the computer program from the recording medium 11H, the computer program is installed at the auxiliary storage device 11F.

The computer program may be downloaded from another computer via a communication network such as a local area network (LAN) or the Internet, and installed at the auxiliary storage device 11F.

The auxiliary storage device 11F stores various installed computer programs as well as necessary files, data, and the like. As the auxiliary storage device 11F, various storage media and storage devices such as a read only memory (ROM), a hard disk drive (HDD), a solid state drive (SSD), and a flash memory can be used as appropriate.

The memory device 11G temporarily stores computer programs read from the auxiliary storage device 11F and data used by the computer programs when a program start instruction is issued. For example, a random access memory (RAM) can be used as the memory device 11G.

The CPU 11A executes various computer programs loaded into and stored in the memory device 11G, and implements various functions related to the navigation device 30 according to the computer programs.

The interface device 11B is a device that is connected to a communication device 11J and communicates with the communication device 11J. The communication device 11J is communication means connected to the communication network NW illustrated in FIG. 1.

The display device 11C, for example, displays a graphical user interface (GUI) according to a computer program executed by the CPU 11A. For example, a known organic electro luminescence (EL) display, a liquid crystal display (LCD), or the like can be used as the display device 11C.

The input device 11D receives input of various operation instructions related to the navigation device 30 from a user of the vehicle 100, or the like. The input device 11D is, for example, at least one of an instruction input device that receives input through user's operation input and a microphone that receives voice input. Examples of the instruction input device include a button, a pointing device such as a mouse or a trackball, and a keyboard. The instruction input device may be a touch panel provided integrally with the display device 11C.

Next, an example of the hardware configuration of the operation terminal 20 is described. The operation terminal is implemented by, for example, the hardware 11 described above. Note that the hardware 11 of the operation terminal may not include the drive device 11E and the recording medium 11H. Computer programs for implementing various functions of the operation terminal 20 are provided by being stored in advance in the auxiliary storage device 11F, for example. The CPU 11A executes various computer programs loaded into and stored in the memory device 11G, and implements various functions related to the operation terminal 20 according to the computer programs.

Next, an example of the hardware configuration of the web server 50 and the navigation server 60 is described. The web server 50 and the navigation server 60 are implemented by, for example, the hardware 11 described above, respectively. Note that the hardware 11 of each of the web server 50 and the navigation server 60 may not include the display device 11C and the input device 11D. The CPU 11A executes various computer programs loaded into and stored in the memory device 11G, and implements various functions related to each of the web server 50 and the navigation server 60 according to the computer programs.

Note that the computer program for executing the above information processing in the above-described embodiment has a module configuration including each of the plurality of functional units, and as actual hardware, for example, the CPU (processor circuit) reads the information processing program from the ROM or the HDD and executes the read information processing program, so that each of the plurality of functional units described above is loaded into the RAM (main memory) and generated on the RAM (main memory).

As an example, the CPU 11A of the navigation device 30 loads various computer programs stored in the auxiliary storage device 11F into the memory device 11G and executes the loaded computer programs, thereby implementing functions as the request unit 30A, the acquisition unit 30B, the own-location estimation unit 30C, the map matching unit 30D, the route generation unit 30E, the parking space selection unit the guidance information generation unit 30G, the screen generation unit 30H, the screen control unit 30I, the parking detection unit 30J, the storage unit 30K, and the control unit 30L. The computer program executed on the navigation device 30 is an example of an information presentation program.

As an example, the CPU 11A of the operation terminal 20 loads various computer programs stored in the auxiliary storage device 11F into the memory device 11G and executes the loaded computer programs, thereby implementing functions as the communication unit 20A, the destination setting unit the screen generation unit 20C, the screen control unit the control unit 20E, the storage unit 20F, and the reception unit 20G. The computer program executed on the operation terminal 20 is an example of an information display program.

As an example, the CPU 11A of the web server 50 loads various computer programs stored in the auxiliary storage device 11F into the memory device 11G and executes the loaded computer programs, thereby implementing functions as the communication unit 50A, the processing unit 50B, and the storage unit 50C.

As an example, the CPU 11A of the navigation server 60 loads various programs stored in the auxiliary storage device 11F into the memory device 11G and executes the loaded computer programs, thereby implementing functions as the communication unit 60A, the DB unit 60B, and the storage unit 60C.

A part or all of each of the plurality of functional units described above can also be implemented using dedicated hardware such as an application specific integrated circuit (ASIC) or a field-programmable gate array (FPGA).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A non-transitory computer-readable medium on which programmed instructions are stored, wherein the instructions, when executed by a computer of an information display device that is able to communicate via a network with a navigation device configured to guide a vehicle to a parking location and includes a display, cause the computer to perform:
acquiring, as parking location information, a current location of the vehicle transmitted from the navigation device that has detected parking of the vehicle; and
causing the display to display a parking location in accordance with the acquired parking location information.

2. The non-transitory computer-readable medium according to claim 1, wherein the parking location is a parking space in a parking lot.

3. The non-transitory computer-readable medium according to claim 1, wherein the parking location is displayed with a predetermined symbol.

4. The non-transitory computer-readable medium according to claim 1, wherein the parking location is displayed with character information.

5. The non-transitory computer-readable medium according to claim 1, wherein
the parking location is a parking space in a parking lot located at a facility, and
the instructions further cause the computer to perform, when a space to be visited at the facility is selected by a user, setting the acquired parking location as a starting point and setting location information indicating a location of the space to be visited as an end point, to cause the display to display a route from the starting point to the end point, based on network data for walking regarding the facility and the parking lot.

6. An information display device that is able to communicate via a network with a navigation device configured to guide a vehicle to a parking location, the information display device comprising:
a display;
a memory; and
a hardware processor coupled to the memory,
the hardware processor being configured to:
acquire, as parking location information, a current location of the vehicle transmitted from the navigation device that has detected parking of the vehicle; and
cause the display to display a parking location in accordance with the acquired parking location information.

7. An information display method in an information display device that is able to communicate via a network with a navigation device configured to guide a vehicle to a parking location and includes a display, the information display method performing:
acquiring, as parking location information, a current location of the vehicle transmitted from the navigation device that has detected parking of the vehicle; and
causing the display to display a parking location in accordance with the acquired parking location information.

8. The information display method according to claim 7, wherein the parking location is a parking space in a parking lot.

9. The information display method according to claim 7, wherein the parking location is displayed with a predetermined symbol.

10. The information display method according to claim 7, wherein the parking location is displayed with character information.

11. The information display method according to claim 7, wherein
the parking location is a parking space in a parking lot located at a facility, and
the information display method performs, when a space to be visited at the facility is selected by a user, setting the acquired parking location as a starting point, and setting location information indicating a location of the space to be visited as an end point, to cause the display to display a route from the starting point to the end point, based on network data for walking regarding the facility and the parking lot.
